(19) United States
(12) Patent Application Publication
(10) Pub. No.: US 2017/0204638 A1
(43) Pub. Date: Jul. 20, 2017

(54) THEFT DETERRENT TAG

(71) Applicant: Universal Surveillance Systems, LLC, Rancho Cucamonga, CA (US)

(72) Inventors: Marc Trincale, Rancho Cucamonga, CA (US); Alejandro Molina, Rancho Cucamonga, CA (US); Michael Sayegh, Rancho Cucamonga, CA (US)

(21) Appl. No.: 15/368,628

(22) Filed: Dec. 4, 2016

Related U.S. Application Data
(60) Provisional application No. 62/263,096, filed on Dec. 4, 2015.

(51) Int. Cl. E05B 73/00; G07C 9/00; G08B 13/24

(52) U.S. Cl. CPC E05B 73/0035; G08B 13/2417; G07C 9/00944

(57) ABSTRACT

The present invention discloses a theft deterrent tag, comprising an adjustable housing that includes a first piece that is mechanically moved from open, unlocked position to a closed, locked position with a second piece assembly without use of tools. Theft deterrent tag further includes a benefit denial mechanism.

### CROSS-REFERENCE TO RELATED APPLICATIONS

This Application claims the benefit of priority of co-pending U.S. Utility Provisional Patent Application 62/263,096, filed Dec. 4, 2015, the entire disclosure of which is expressly incorporated by reference in its entirety herein.

All documents mentioned in this specification are herein incorporated by reference to the same extent as if each individual document was specifically and individually indicated to be incorporated by reference.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

Field of the Invention

One or more embodiments of the invention relate to theft deterrent tags and, more particularly, a theft deterrent tag with form-factor adapted for protection of small, fragile (or delicate) merchandise.

Description of Related Art

Conventional theft deterrent tags are well known and have been in use for a number of years. Regrettably, most conventional theft deterrent tags are bulky, which makes it inconvenient (if not difficult) to try-on a wearable article such as a pair of glasses.

Further, most conventional theft deterrent tags do not provide “benefit-denial” protection mechanism. Lack of “benefit-denial” mechanism in conventional theft deterrent tags means that the article does not get damaged while the theft deterrent tag is tampered and removed from the article. In other words, unauthorized removal of the theft deterrent tag from the article would not cause any damage to the article and therefore, such tampering would not deny would be thief the benefit of an undamaged article. “Benefit-denial” mechanisms incorporated in theft deterrent tags would damage the article if theft deterrent tag was tampered and hence, denying would be thief the benefit of having an undamaged article.

Additionally, most conventional theft deterrent tags require dedicated tool to engage and disengage with an article to be protected. In particular, the use of tool to engage the theft deterrent tag with an article is labor intensive and may also damage the article due to operator error (e.g., exerting too much pressure (force) using the tools to secure the theft deterrent tags onto the article).

As importantly, most conventional theft deterrent tags are not adjustable to accommodate different size articles (for example, eyewear). Although some conventional theft deterrent tags use lanyards that allow for adjustability, the lanyards may easily be severed and the article removed.

Other conventional theft deterrent tags do not incorporate technologies for enhanced protection such as Electronic Article Surveillance (EAS) systems or Radio Frequency Identification (RFID) electronics. This is particularly true for wearable article such as eyewear where the weight of the battery and the electronics within the theft deterrent tag may give the “feeling” that the article is heavy on one side (the side on which the theft deterrent tag is mounted).

Accordingly, in light of the current state of the art and the drawbacks to current theft deterrent tags mentioned above, a need exists for a theft deterrent tag that would have a small-form factor, would provide a “benefit denial” mechanism, not require tool for engagement with an article, would be adjustable, and would incorporate electronic technologies for enhanced protection, but without affect on try-on experience of article by users.

### BRIEF SUMMARY OF THE INVENTION

A non-limiting, exemplary aspect of an embodiment of the present invention provides a theft deterrent tag, comprising:

an adjustable housing that includes:

a first piece that is mechanically moved from open, unlocked position to a closed, locked position with a second piece assembly without use of tools;

a benefit denial mechanism; and

an electronic article surveillance module.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A and 1B are non-limiting, exemplary illustrations of a theft deterrent tag mounted onto an article in accordance with one or more embodiments of the present invention;

FIGS. 2A-1 to 2G are non-limiting, exemplary illustrations of the various perspective views of the theft deterrent tag shown in FIGS. 1A and 1B in both closed and open positions, but without the eyewear;

FIG. 3 is a non-limiting exemplary exploded view illustration of the various components of the theft deterrent tag in accordance with one or more embodiments of the present invention;

FIGS. 4A to 4D are non-limiting, exemplary illustrations of the various perspective views of a first piece of the theft-deterrent tag shown in FIGS. 1A to 3 in accordance with one or more embodiments of the present invention;

FIGS. 5A-1 to 5I are non-limiting, exemplary illustrations of the various perspective views of a second piece assembly of the theft-deterrent tag shown in FIGS. 1A to 4D in accordance with one or more embodiments of the present invention;

FIG. 6 is a non-limiting, exemplary illustration of the perspective view of a lock mechanism of the theft deterrent tag shown in FIGS. 1A to 5I in accordance with one or more embodiments of the present invention; and

FIGS. 7A to 11I are non-limiting, exemplary illustrations of a theft deterrent tag in accordance with another embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention provide a theft deterrent tag that has a small-form factor, provides a “benefit denial” mechanism, does not require tool for engagement with an article, is adjustable to be mounted onto most types of articles (e.g., different size eyewear), and incorporates electronic technologies for enhanced protection, but without affect on try-on experience of article by users.

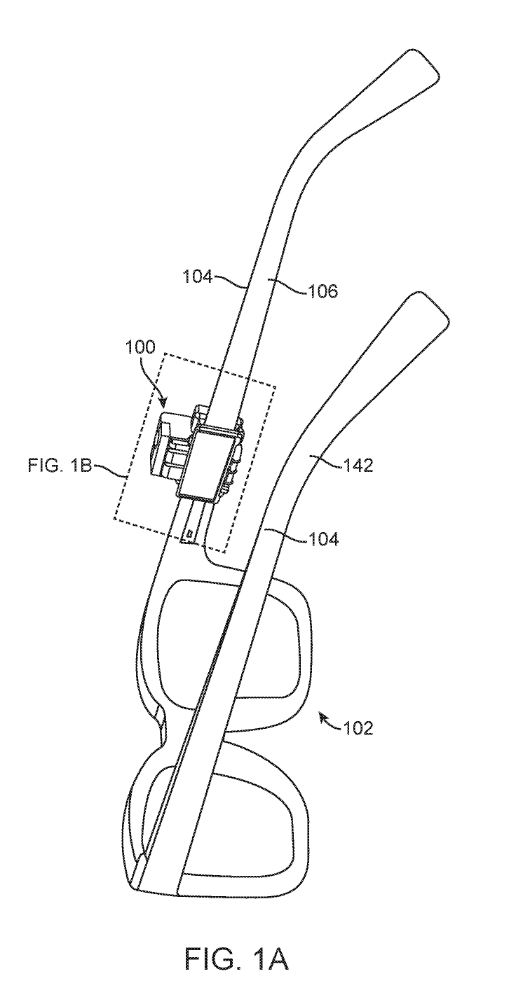

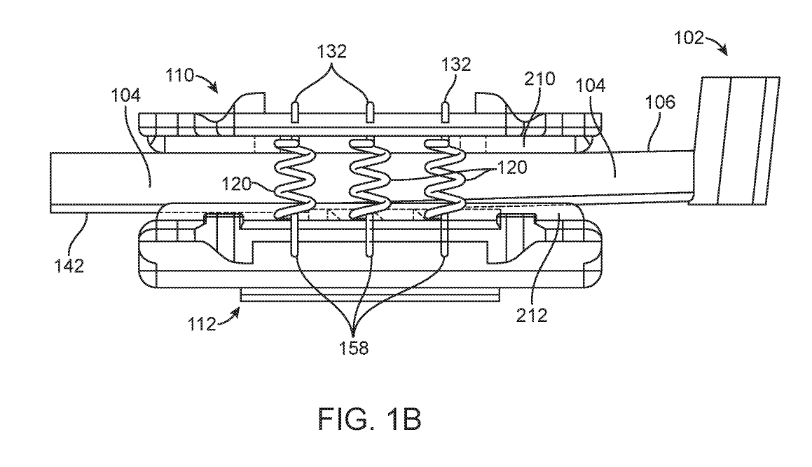

FIGS. 1A and 1B are non-limiting, exemplary illustrations of a theft deterrent tag mounted onto an article in accordance with one or more embodiments of the present invention. As illustrated in FIGS. 1A and 1B, theft-deterrent tag 100 has a small-form factor and may easily be connected to a template 104 of an eyewear 102 at a position between interior facing side 106 of template 104 and the user head profile (not shown) so that eyewear 102 may be tried-on by users with comfort while being protected against theft.

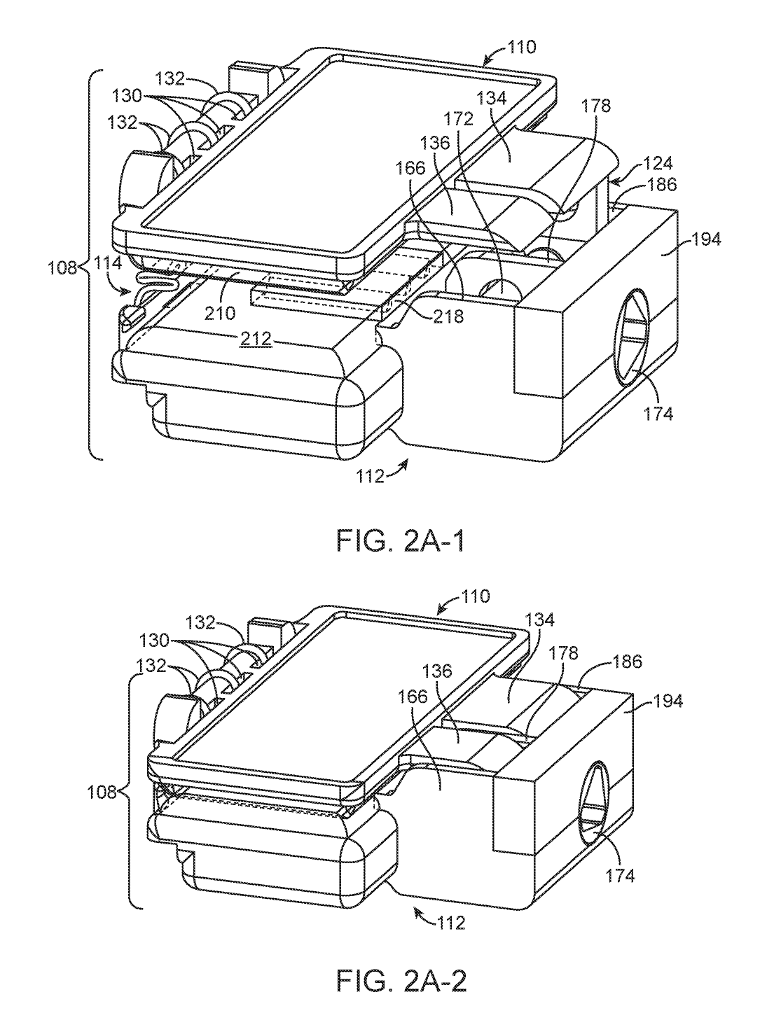

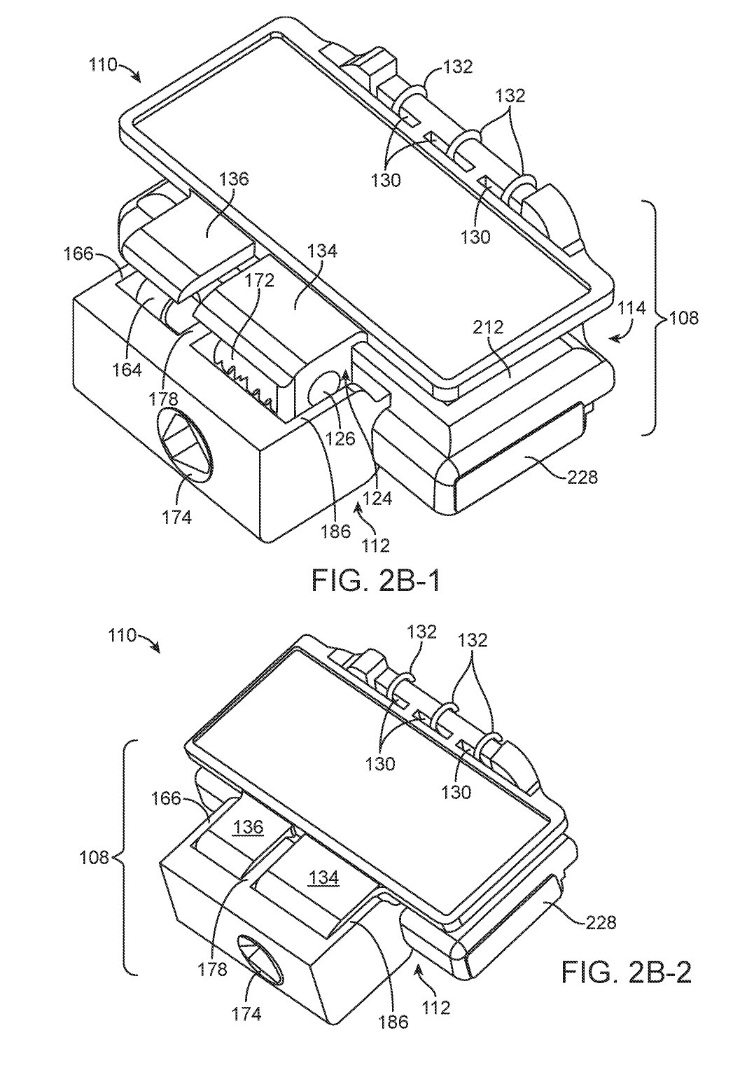

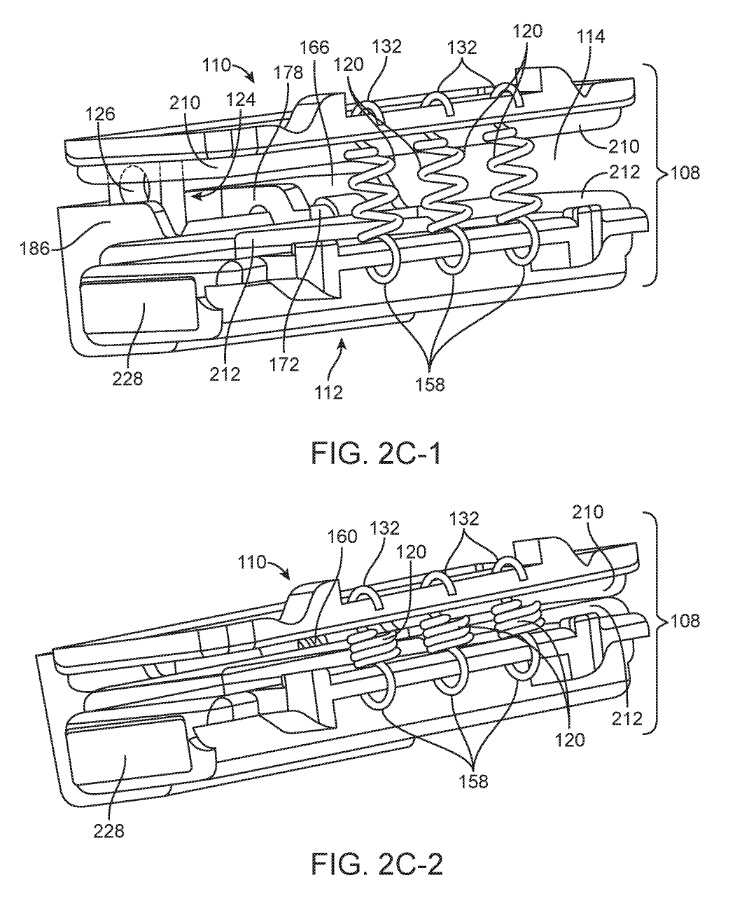

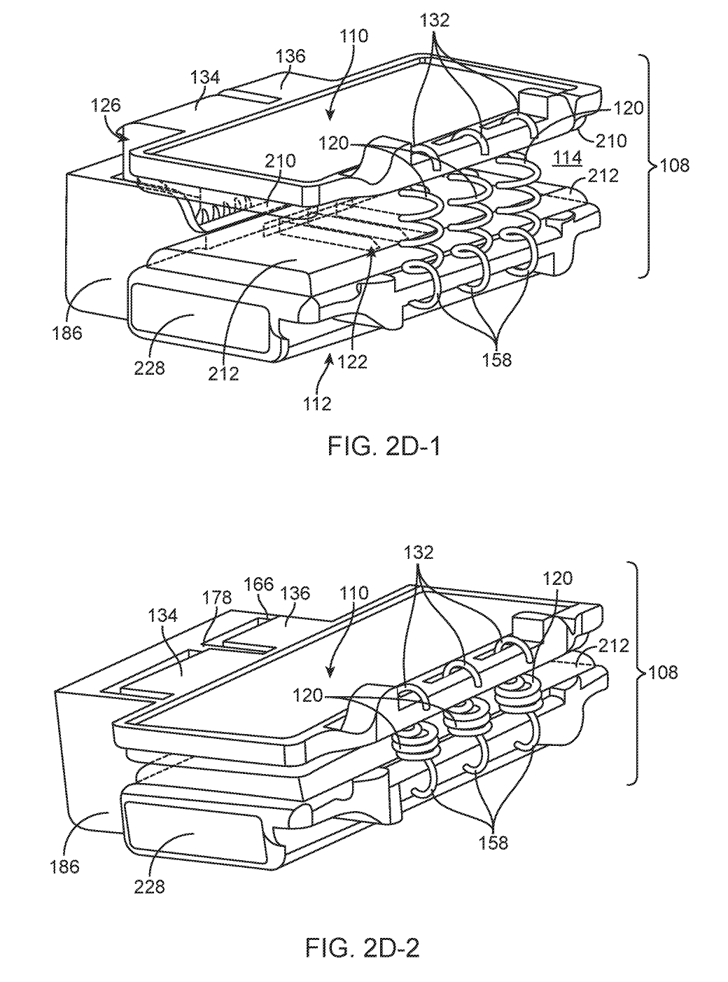

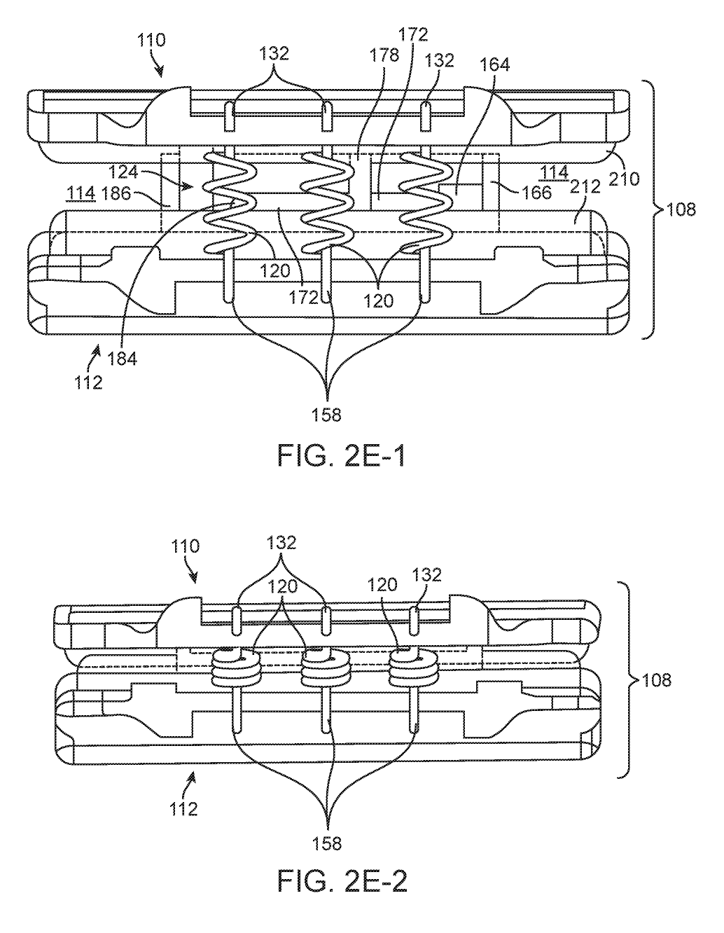

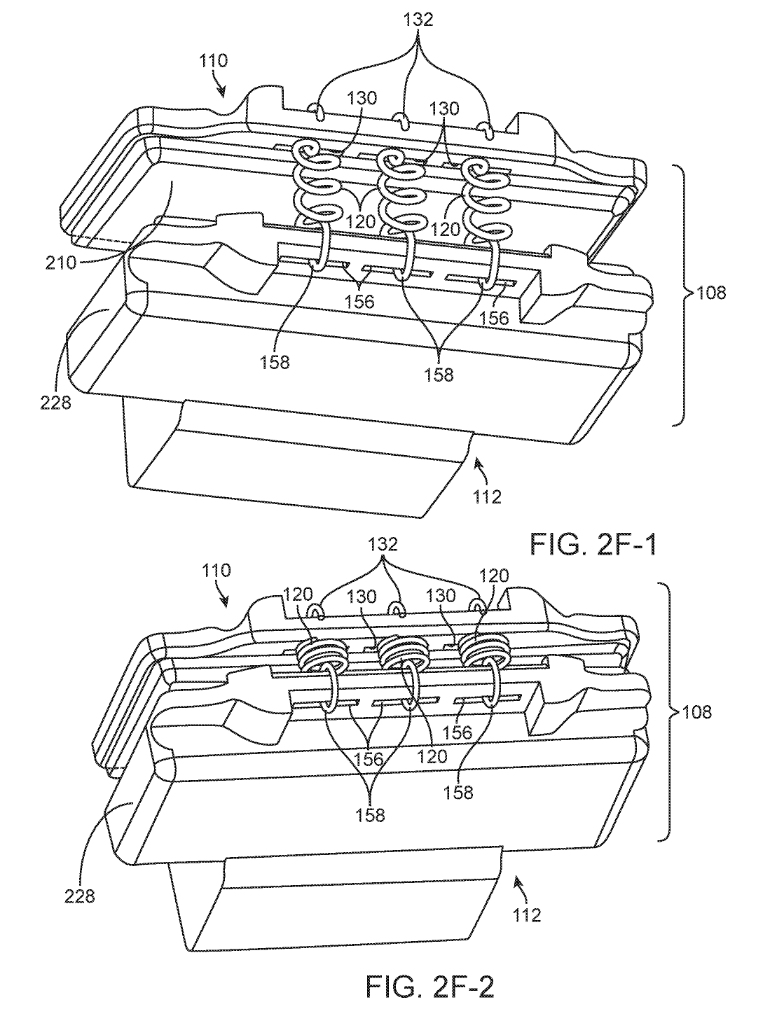

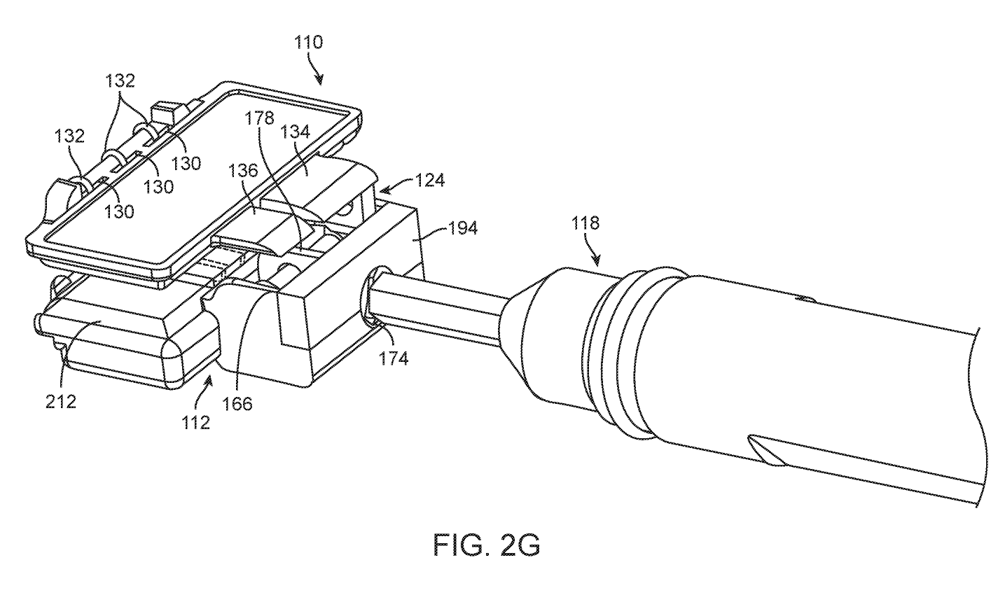

FIGS. 2A-1 to 2G are non-limiting, exemplary illustrations of the various perspective views of the theft deterrent tag shown in FIGS. 1A and 1B in both closed and open positions, but without the eyewear. As detailed below, theft deterrent tag 100 is comprised of an adjustable housing 108 that includes a first piece (or cover) 110 that is mechanically moved from open, unlocked position (FIGS. 2A-1, 2B-1, 2C-1, 2D-1, 2E-1, 2F-1) to a closed, locked position (FIGS. 2A-2, 2B-2, 2C-2, 2D-2, 2E-2, and 2F-2) with a second piece (the main housing portion) assembly 112 without use of locking tools.

While theft deterrent tag 100 is in the open, unlocked position (FIGS. 2A-1, 2B-1, 2C-1, 2D-1, 2E-1, 2F-1), template 104 of eyewear 102 may be inserted within and through space or gap 114 between first piece 110 and second piece assembly 112 of theft deterrent tag 100. Thereafter, first piece 110 may be pushed towards second piece assembly 112 along direction 116 to move first piece 110 to the closed, locked position (FIGS. 2A-2, 2B-2, 2C-2, 2D-2, 2E-2, and 2F-2) with second piece assembly 112 to secure theft deterrent tag 100 onto article 100.

FIG. 2G is non-limiting, exemplary illustration of a non-limiting, exemplary method of unlocking theft deterrent tag from closed, locked position (FIGS. 2A-2, 2B-2, 2C-2, 2D-2, 2E-2, and 2F-2) to open, unlocked position (FIGS. 2A-1, 2B-1, 2C-1, 2D-1, 2E-1, 2F-1) using a key in accordance with one or more embodiments of the present invention. As illustrated in FIG. 2G and further detailed, at point of sale, an authorized user may use key 118 to unlock and open theft deterrent tag 100 to safely remove the protected article (not shown in FIG. 2G). Accordingly, first piece 110 is mechanically unlocked from second piece assembly 112 using key 118, with first piece 110 continuously engaged with second piece assembly 112 at both locked and unlocked positions by a set of resilient members 120. As indicated above, first piece 110 is locked with second piece assembly 112 without any tools.

As further illustrated (best shown in FIG. 2D-1 and FIG. 3 and further detailed below), one or more embodiments of the present invention provide a benefit denial mechanism 122 that would discourage would be theft of article 102 and tampering with and unauthorized removal of theft deterrent tag 100.

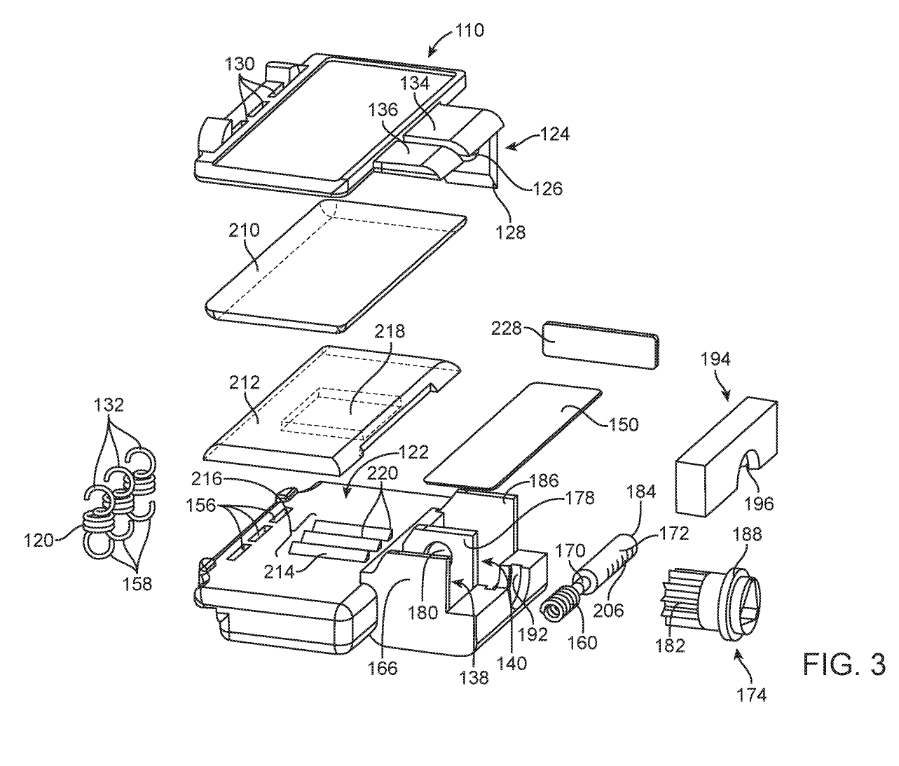

FIG. 3 is a non-limiting exemplary exploded view illustration of the various components of the theft deterrent tag in accordance with one or more embodiments of the present invention. The exploded view shown in FIG. 3 illustrates disassembled, separated components that show the cooperative working relationship, orientation, positioning, and exemplary manner of assembly of the various components of theft deterrent tag 100 in accordance with one or more embodiments of the present invention, with each component detailed below.

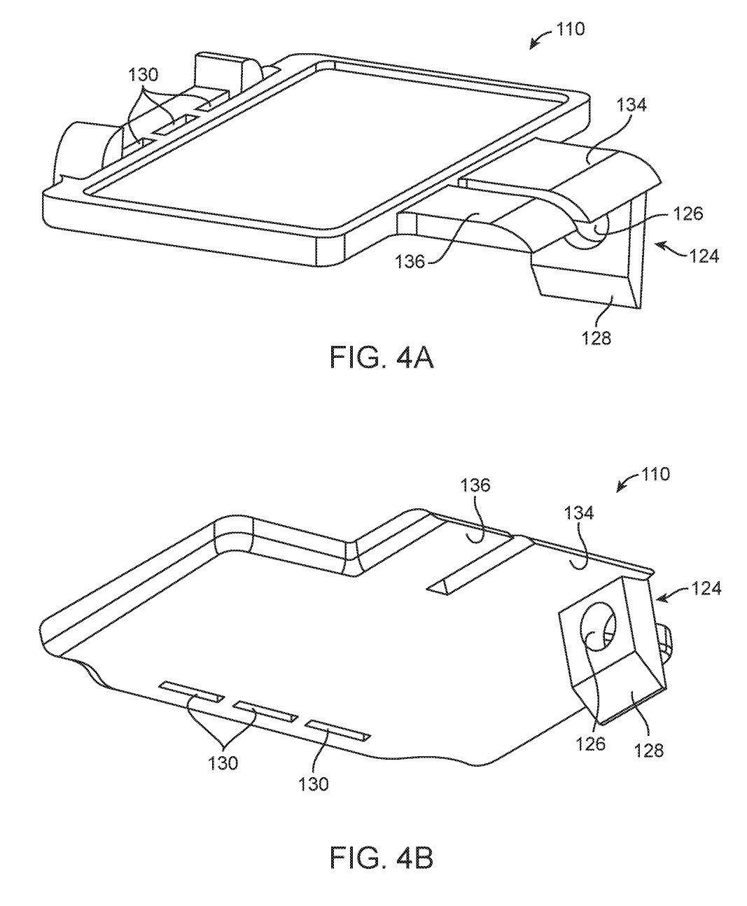

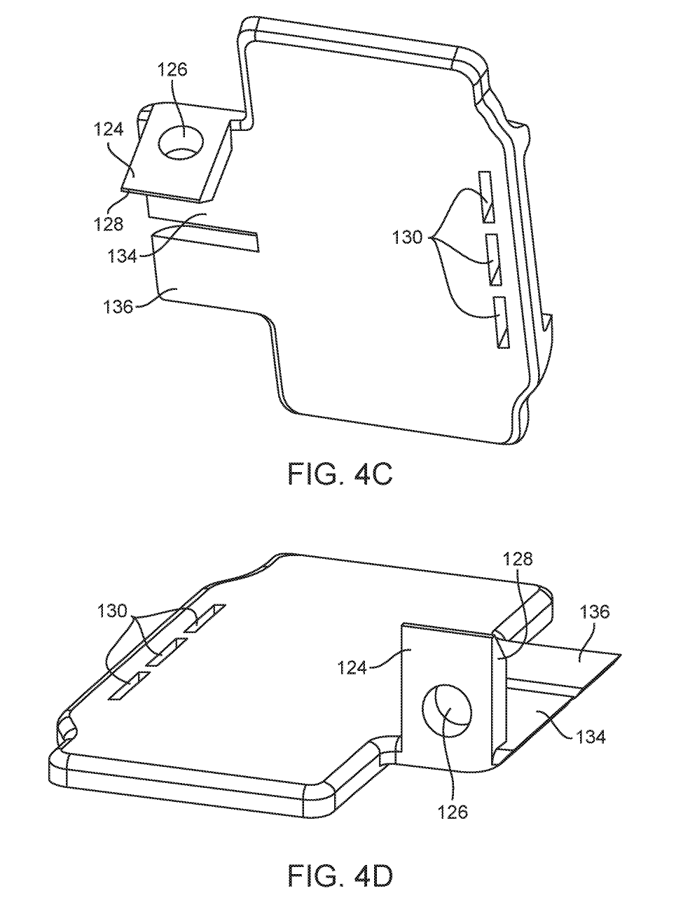

FIGS. 4A to 4D are non-limiting, exemplary illustrations of the various perspective views of a first piece of the theft-deterrent tag shown in FIGS. 1A to 3 in accordance with one or more embodiments of the present invention. As illustrated in FIGS. 1A to 4D, in general, first piece 110 may comprise of a thin plastic material and when theft deterrent tag 100 is mounted onto template 104 of eyewear 102, is positioned along interior side 106 (between the user head-profile and eyewear template 104) of eyewear 102.

First piece 110 includes a first cover flange 134 from which a locking flange 124 is extended (perpendicularly from a side thereof) that includes an interlocking opening 126, with locking flange 124 having a beveled distal edge 128. First piece 110 further includes a second cover flange 136 and a first set of tension openings 130 that receive a first end 132 of a set of resilient members 120. As detailed below, first and second cover flanges 134 and 136 cover over lock-portion 138 and 140 of second piece assembly 112.

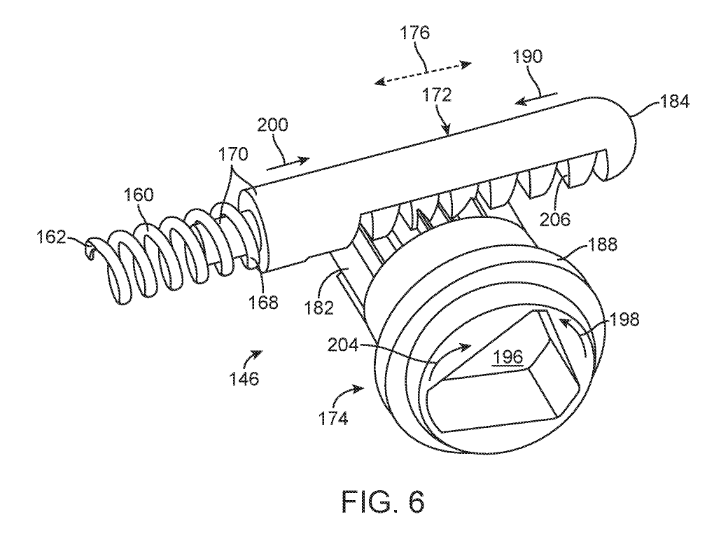

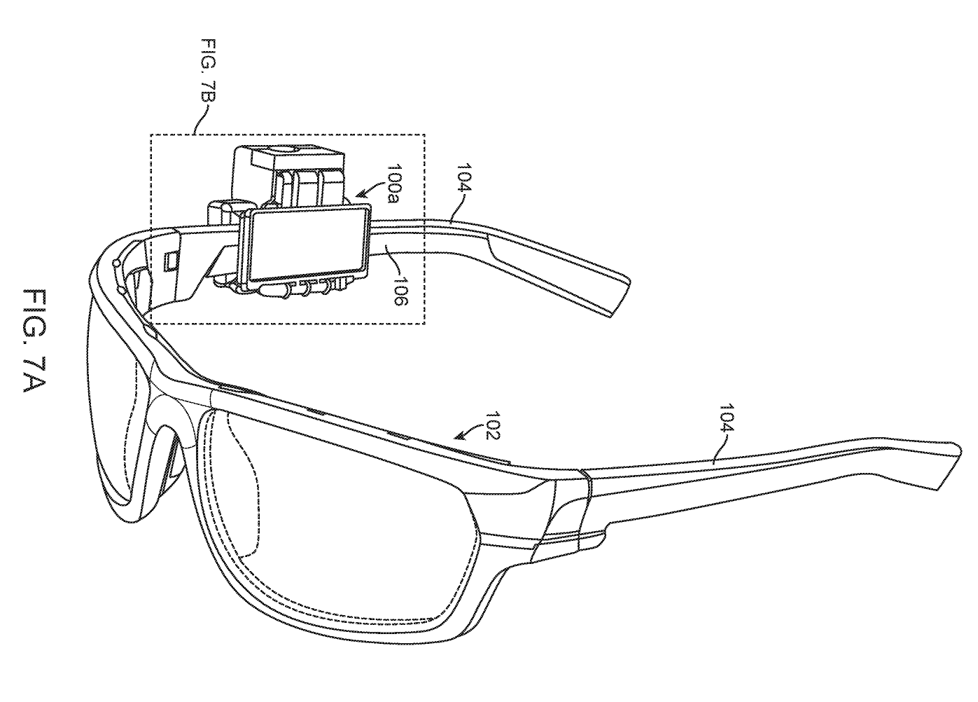

FIGS. 5A-1 to 5I are non-limiting, exemplary illustrations of the various perspective views of a second piece assembly of the theft-deterrent tag shown in FIGS. 1A to 4D in accordance with one or more embodiments of the present invention. As illustrated in FIGS. 1A to 5I, in general, when theft deterrent tag 100 is mounted onto template 104 of eyewear 102, second piece assembly 112 is positioned along exterior side 142 (FIG. 1A) of template 104 of eyewear 102. Second piece assembly 112 is comprised of a first portion 144 that houses a locking mechanism 146 (best illustrated in FIG. 6), a second portion 148 that houses one or more electronic modules 150, a surface 152 that accommodates benefit denial mechanism 122, and an third portion 154 that accommodates resilient members 120.

Second piece assembly 112 further includes a second set of corresponding number of tension openings 156 at third portion 154 that receive a second end 158 of the set of resilient members 120. Resilient members 120 provide tension that enable an adjustable tight fit for securing articles of varying sizes. Resilient members 120 are tension springs that enable tag 100 to be adjustable to accommodate variations in the thickness of the article, while simultaneously, the tension provided ensures that the article cannot be removed without the article being damaged if theft deterrent tag 100 is not properly unlocking by an authorized individual.

First portion 144 of second piece assembly 112 is comprised of one or more compartments (lock portions 138 and 140) that house locking mechanism 146. Locking mechanism 146 (best illustrated in FIG. 6) is comprised of a resilient member 160 with a first end 162 housed within a protruded cavity 164 that extends from a first wall 166 of first compartment (or lock portion) 138. Second end 168 of resilient member 160 is engaged with an end 170 of engagement pin 172.

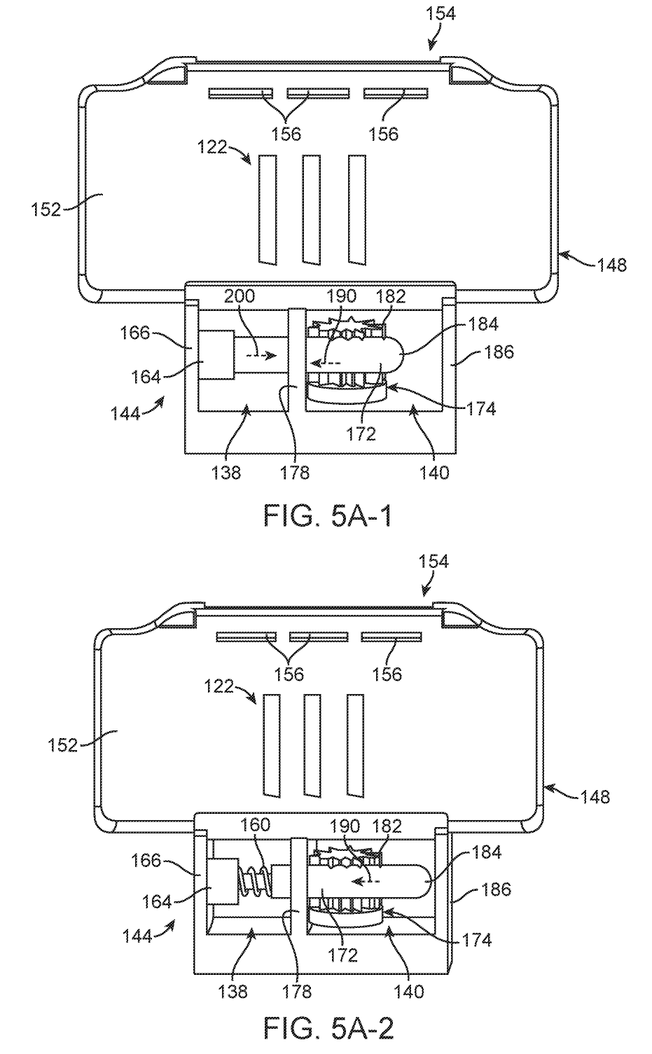

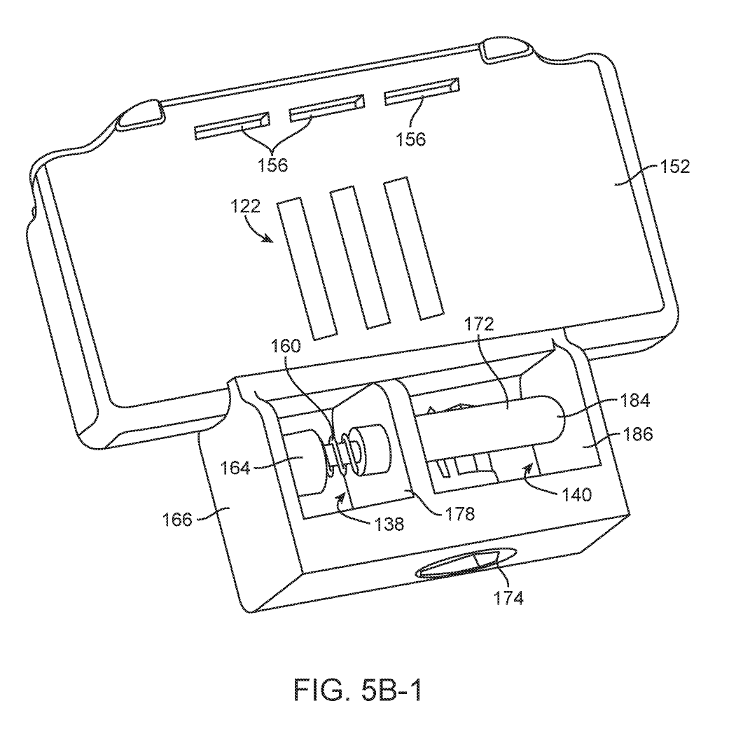

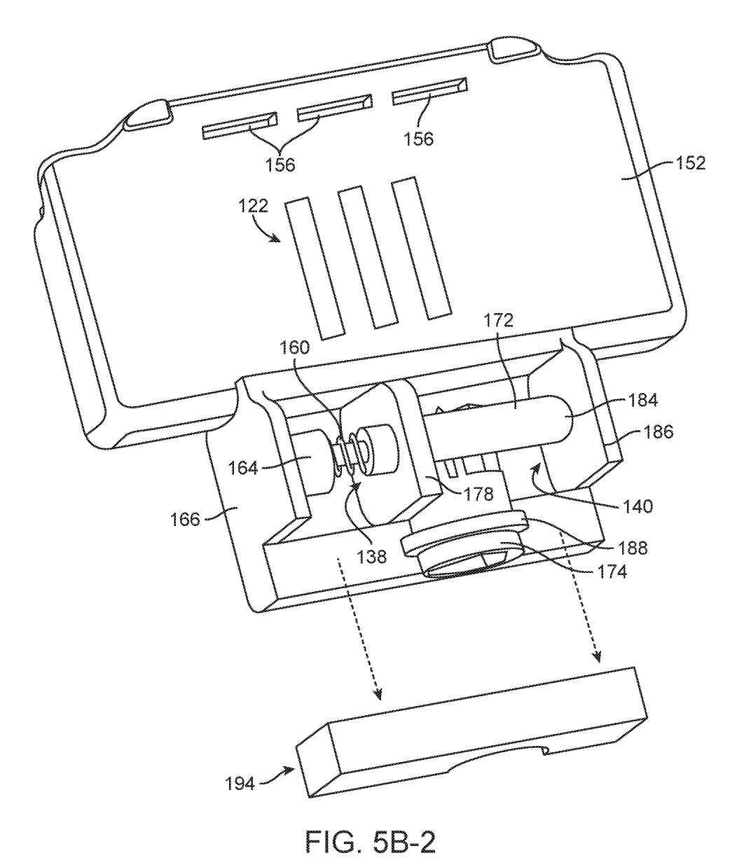

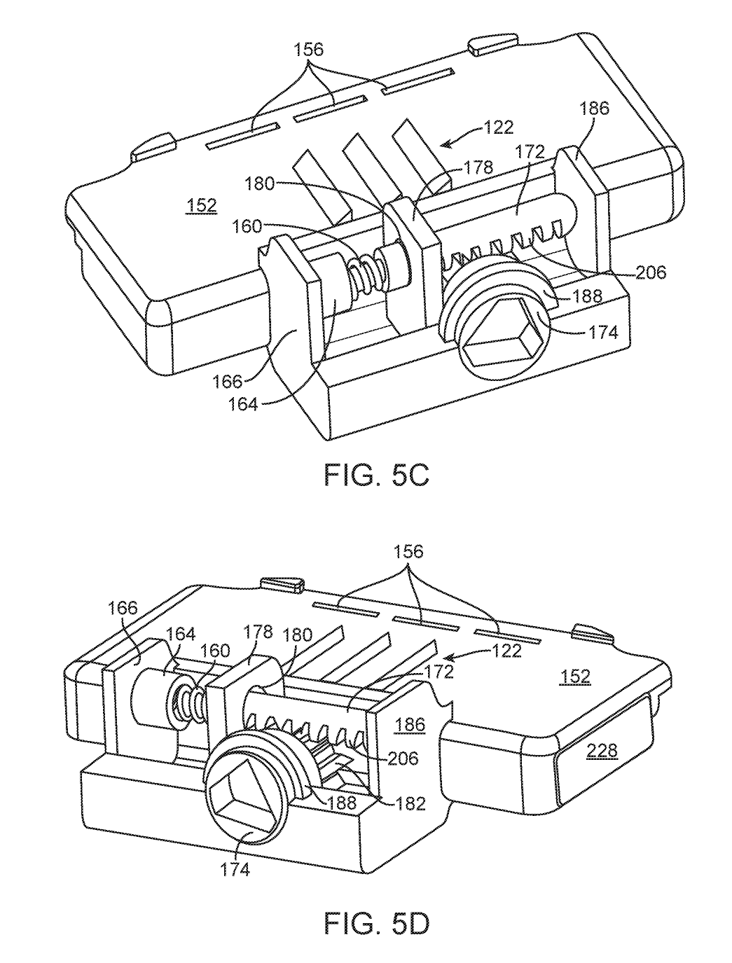

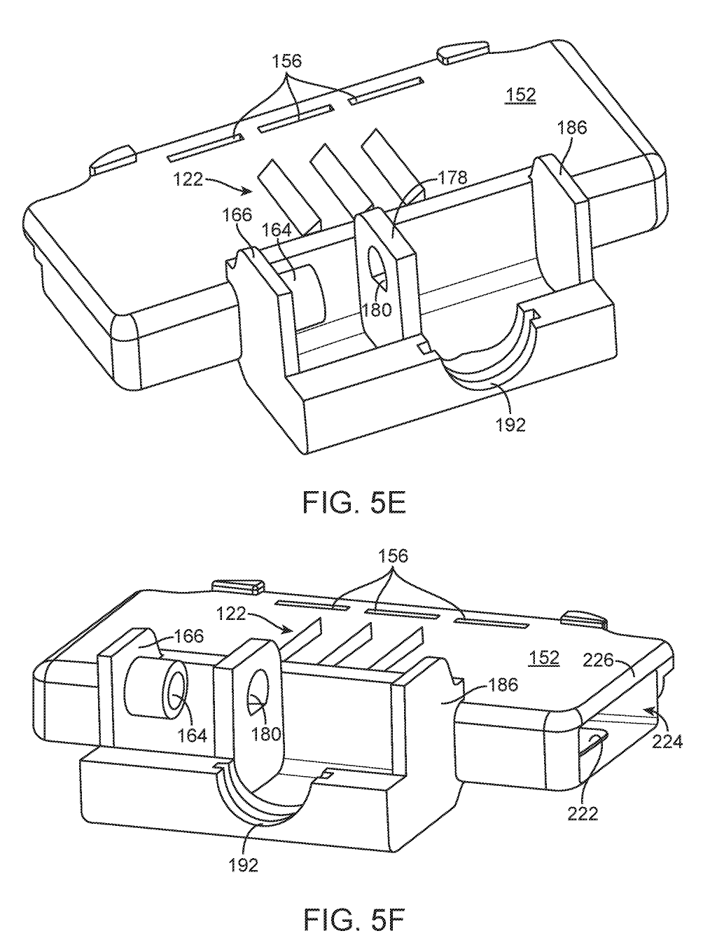

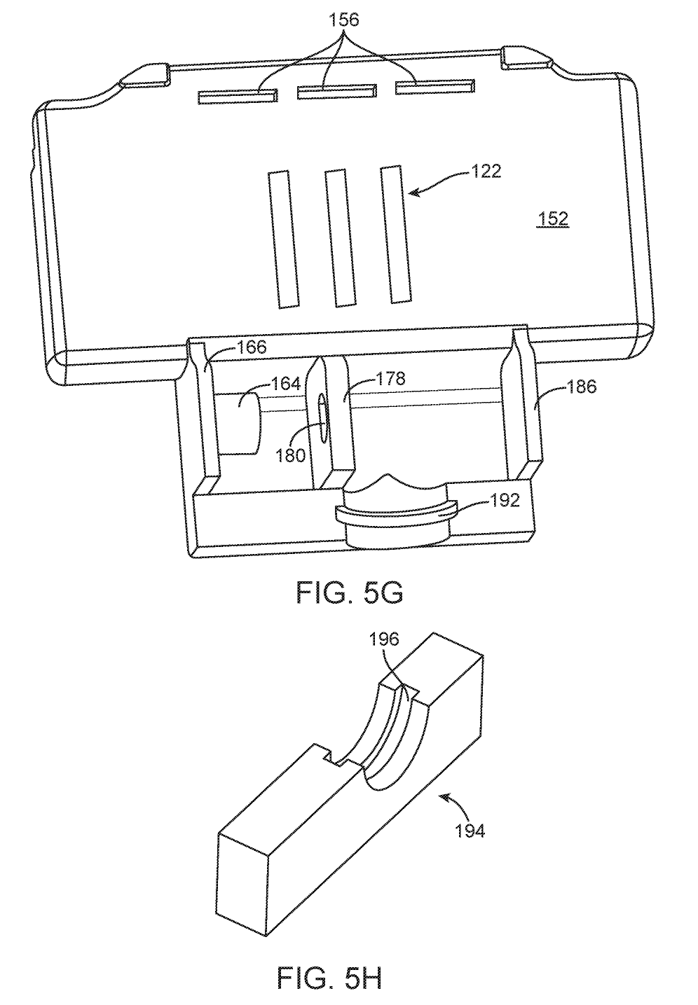

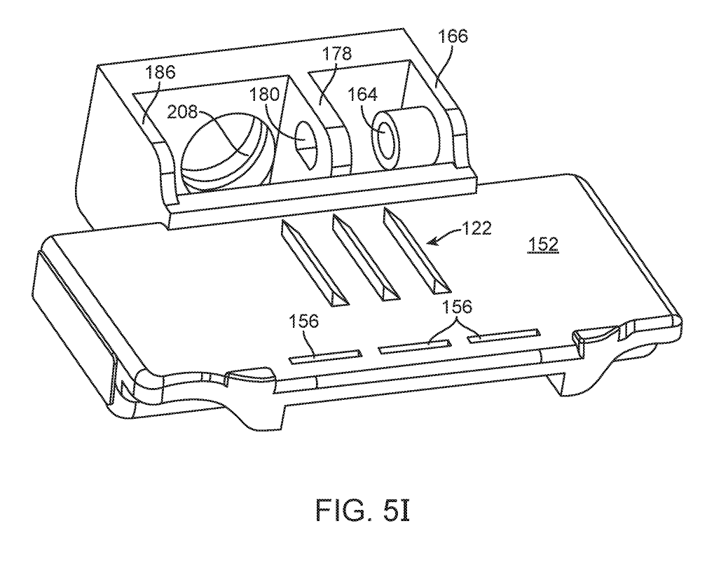

Resilient member 160 biases engagement pin 172 to a locked position (FIGS. 5A-2, 5B-1 to 5D). That is, default position of engagement pin 172 is at locked position. Further included in locking mechanism 146 is an unlocking member 174 that engages with engagement pin 172 to move engagement pin 172 along a linear reciprocating path 176 from a locked position (FIGS. 5A-2, 5B-1 to 5D) to an unlocked position (FIG. 5A-1).

One or more compartments 138 and 140 of first portion 144 of second piece assembly 112 is defined by a dividing interlock wall 178 that includes a guide-opening 180 that facilitates reciprocal (translational, linear) movement 176 of engagement member (pin) 172 of lock mechanism 146 between lock and unlock positions. In this non-limiting, exemplary embodiment, engagement pin 172 included is in a non-limiting form of a linear pinion with gears 206 that engages a set of gears 182 of unlocking member 174. In other words, resilient member 160 engaging engagement end 170 of pinion 172 would push pinion 172 to a locked position (along direction 200), which, in turn, would rotate the contacting gears 182 of unlocking member 174 (along direction 204) to rotate unlocking member 174 clockwise.

As best illustrated in FIG. 6, unlocking member 174 is a free-wheeling gear mechanism. The gears 182 of unlocking member 174 and gears 206 of pinion (pin 172) are always connected and hence, as pinion 172 moves along a linear reciprocating path 176, it rotates gears 182 of unlocking member 174 (clockwise 204 if pinion 172 is moving to locking position shown by arrow 200, and counterclockwise 198 if pinion 172 is moving to unlocking position shown by arrow 190). Therefore, the linear (translational) motion along reciprocating path 176 of pinion 172 is translated to rotation of gears 182 and the rotation of gears 182 is translated to linear (translational) motion of pinion 172.

Free end 184 of engagement pin (or pinion) 172 passes through interlocking opening 126 of locking flange 124 of first piece 110 to thereby lock first piece 110 with second piece assembly 112. Since engagement pin 172 is at a locked position by default, beveled distal edge 128 of locking flange 124 wedges in between a third wall 186 of compartment 140 and free end 184 of engagement pin 172, (as first piece 110 closes) pushing engagement pin 172 back against resilient member 160, moving pin 172 towards first wall 166 (direction shown by arrow 190). Once interlocking opening 126 is aligned with free end 184 of pin 172 (and guide opening 180 of second or divider wall 178, free end 184 snaps back into fully locked position (direction of arrow shown by arrow 200) by moving into interlocking opening 126 (by the force of resilient member 160 being decompressed). To remove theft deterrent tag 100, key 118 is inserted into receiving portion (recess, cavity, etc.) 196 of unlocking member 174 and rotated counterclockwise 198 to move pin 172 out of interlocking opening 126 of first piece 110 in the direction shown by arrow 190 to thereby unlock tag 100 and safely remove article 102.

As best illustrated in FIGS. 3, 6, and 5B-2 to 5D, unlocking member 174 is secured and maintained within second piece assembly 112 by having a annular flange 188 that is inserted into a first half 192 of annular groove 208 (FIG. 5I) of second compartment 140 of locking portion 144 of second piece assembly 112. Second piece assembly 112 may include a section 194 (FIG. 5B-2 and FIG. 5H) that is sonic welded after unlocking member 174 is inserted and positioned in place in relation to second piece assembly 112. Section 194 includes a second half 196 of annular groove 208 of second compartment 140 of locking portion 144 of second piece assembly 112. Accordingly, second piece assembly 112 may comprise of two pieces that are assembled (e.g., sonic welded for example) to form a single integral piece assembly with annular groove 208 as best shown in FIG. 5I.

Referring to FIG. 3, theft deterrent tag 100 further includes a first and a second protective member 210 and 212 associated with respective first piece 110 and second piece assembly 112. In general, template 104 of eyewear 102 may be securely positioned between first piece 110 and second piece assembly 112, sandwiched between respective first and second protective members 210 and 212 (which may comprise of soft robber, for example). First and second protective members 210 and 212 prevent the engaging template 104 of eyewear 102 from damage while eyewear 102 is engaged with theft-deterrent tag 100 and further, prevent eyewear 102 from being removed.

As illustrated in FIG. 3, in this non-limiting, exemplary instance, benefit denial mechanism 122 is positioned between first piece 110 and second piece assembly 112, on second piece assembly 112. The configuration and positioning of benefit denial mechanism 122 in relation to first piece 110 and or second piece assembly 112 of housing 108 may be reversed or varied. That is, benefit denial mechanism 122 may be positioned on first piece 110 instead or both first piece 110 and second piece assembly 112. Benefit-denial mechanism 122 includes a set of protuberances 214 that collectively form a serrated platform 216 that can damage (e.g., scratch) the article if the article forcefully removed (templates are forcefully pulled out of) from the grip of theft-deterrent tag 100.

One or both of the first and second protective members 210 and 212 includes a piercing portion (extremely thin part) 218 wherein added force to remove an article from theft deterrent tag 100 pushes serrated platform 216, penetrating (rupturing) and puncturing through piercing portion 218 to thereby physically contact the article. Due to the tight fit, if theft deterrent tag 100 is handled (gripped by one hand) and article 102 is pulled by the other hand, the tight fit and tight grip of theft deterrent tag 100 would exert a force on first piece 110 and second piece assembly 112 to enable serration platform 216 to push through and rupture piercing portion 218, enabling serrated edges 220 (which are sharp) to physically and mechanically contact template 104 of article 102. As article 102 is pulled to be removed from theft deterrent tag 100, serrated edges 220 (which are sharp and pointy) contact the article and damage it. In other words, while theft-deterrent tag 100 is not tampered, article 102 is protected against theft by theft deterrent tag 100 and physically against damage by the first and second protective members 210 and 212. However, if theft deterrent tag 100 is tampered and article 102 is forcefully removed, article 102 becomes damaged by sharp edges 220.

As best illustrate in FIG. 3, theft deterrent tag 100 may also include electronic article surveillance (EAS) module 150 for added protection. EAS module 150 may comprise of one or more marker circuits (which are well known) that may respond to specific types of electronic surveillance signals of different types of well known EAS systems, non-limiting examples of which may include Magnetic, Acousto-Magnetic (AM), Radio Frequency (RF), Microwave, etc. For example, a marker circuit may comprise a ferrite coil antenna that includes an inductor L and capacitor C (e.g., an LC tank) for radio frequency (RF) systems, amorphous metals for Magnetic systems, magnetostrictive and or ferromagnetic amorphous metals for use with acousto-magnetic (AM) systems, or non-linear elements such as a diode for Microwave systems. It should be noted that several marker circuits of different types may be used within the same theft deterrent tag 100, with each tuned (or adapted) to a different resonant frequency and or system for activation of different types of EAS systems. A non-limiting example of a resonant marker circuit (with passive LC tank) is detailed in U.S. Pat. No. 7,336,180 to Sayegh et al., the entire disclosure of which is incorporated by reference herein in its entirety. In addition to an EAS marker, the tag may also include a Radio Frequency Identification (RFID) module. All electronics may be housed within second portion 148, which is comprise of a chamber 224 (FIG. 5F) with an opening 226 for accessing chamber 224 that may house the one or more electronics module 150, with opening 226 closed with a cap 228 (FIG. 5D).

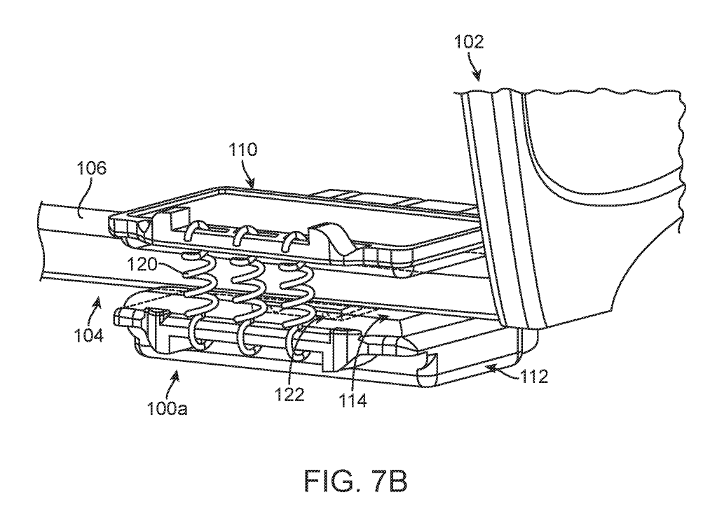

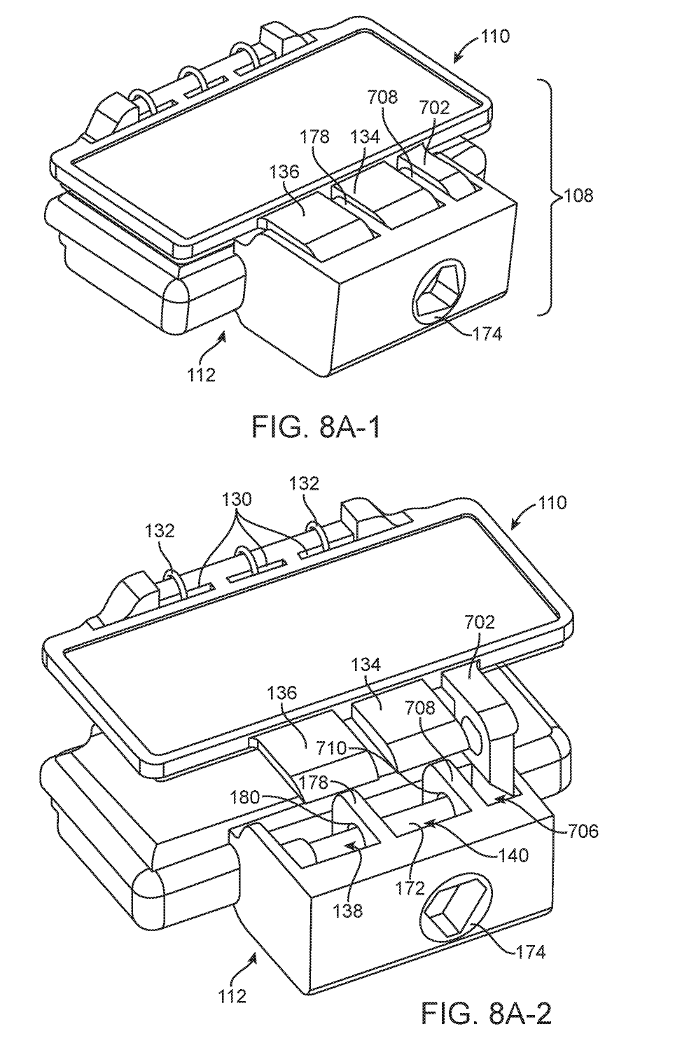

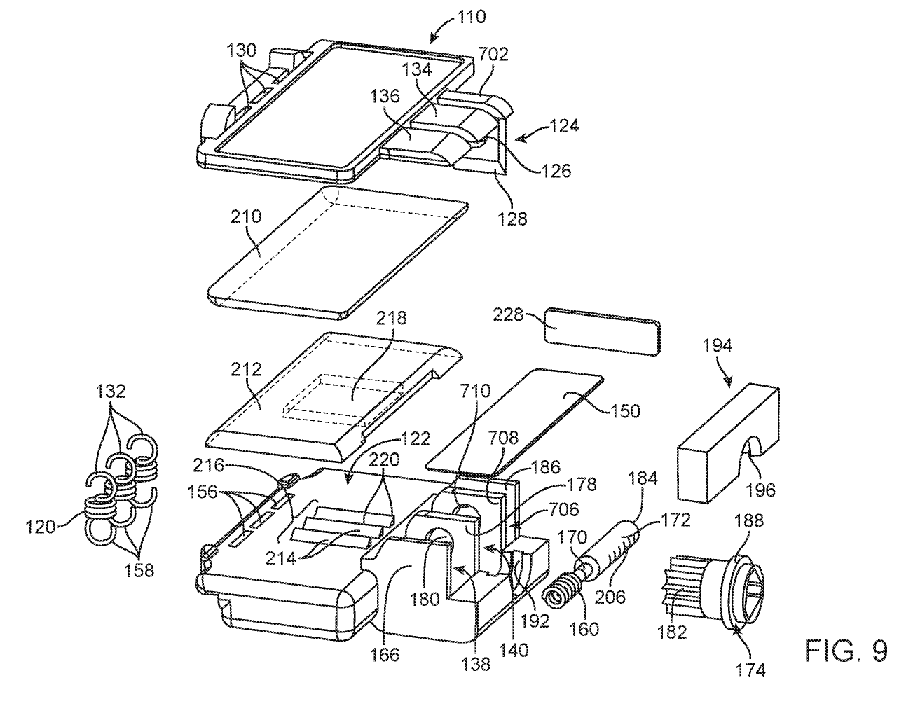

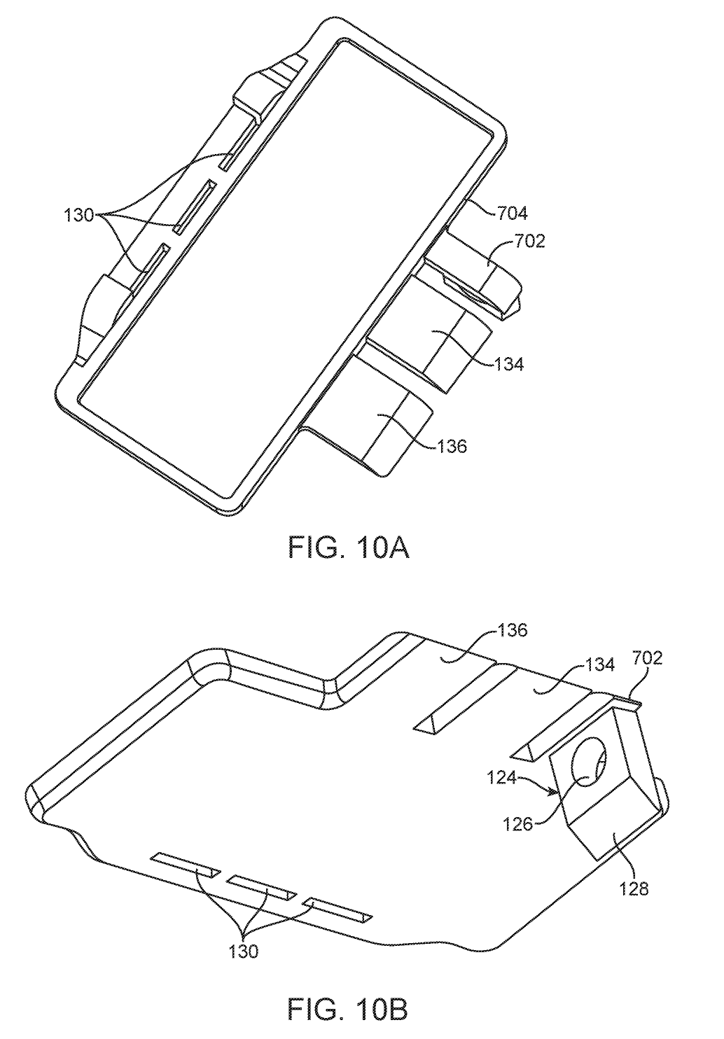

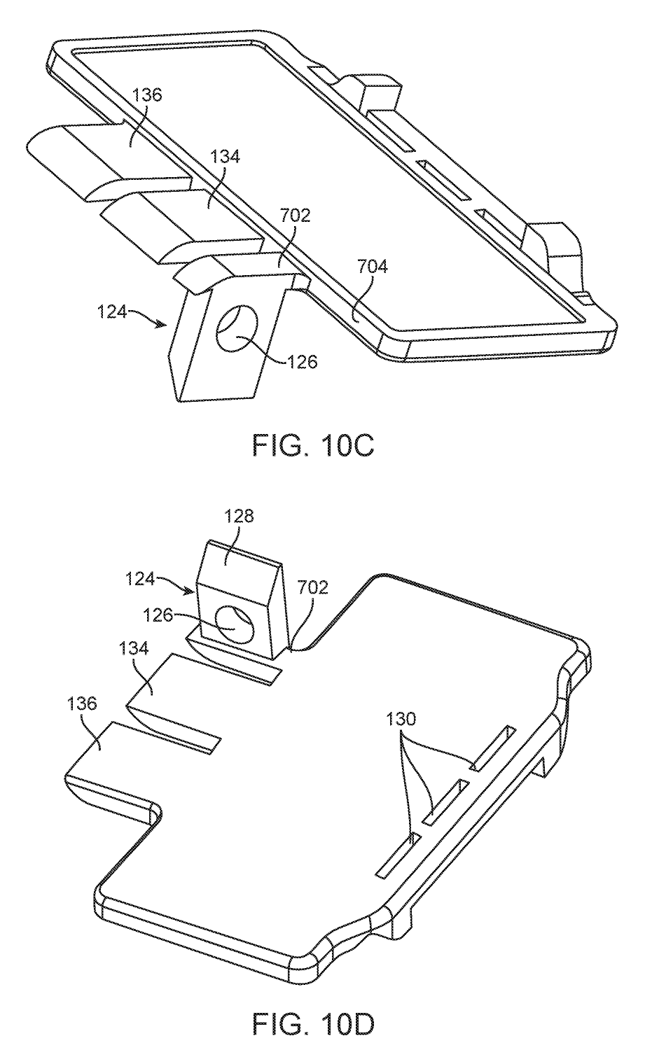

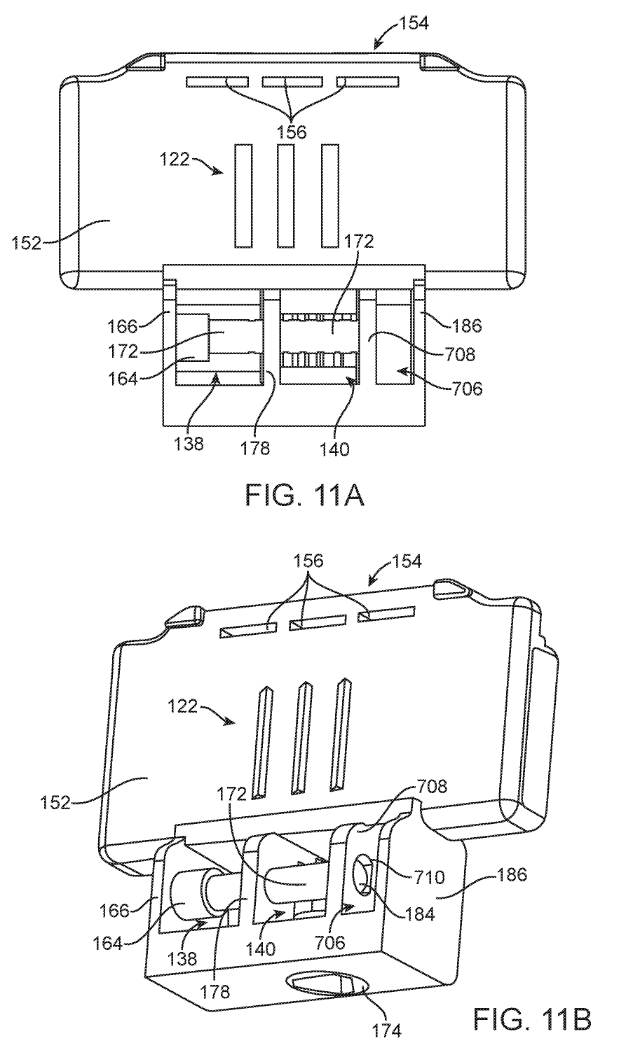

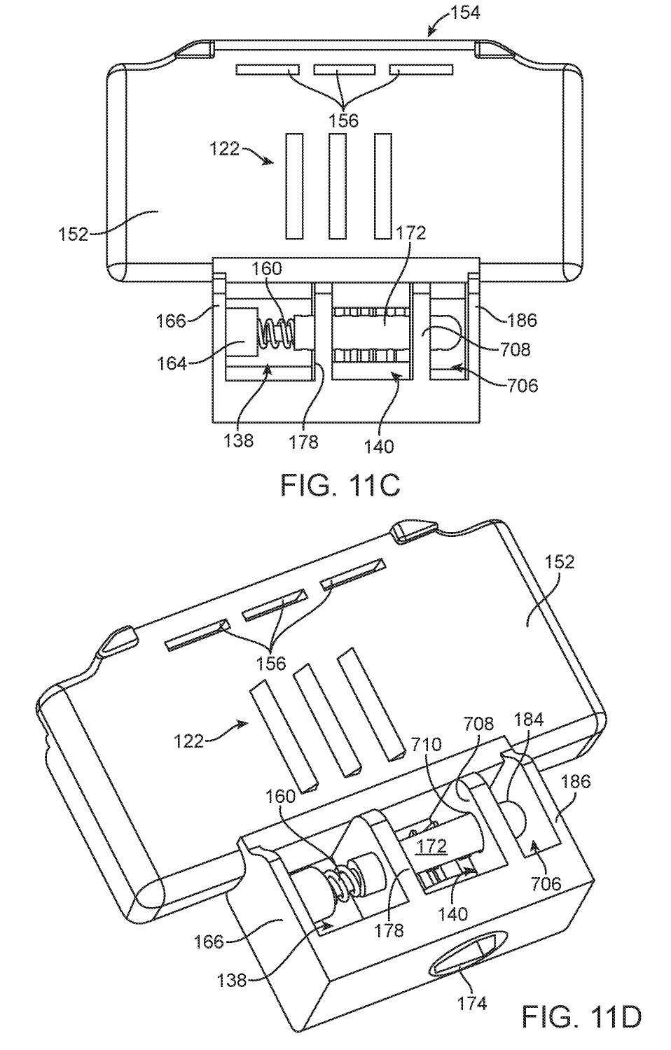

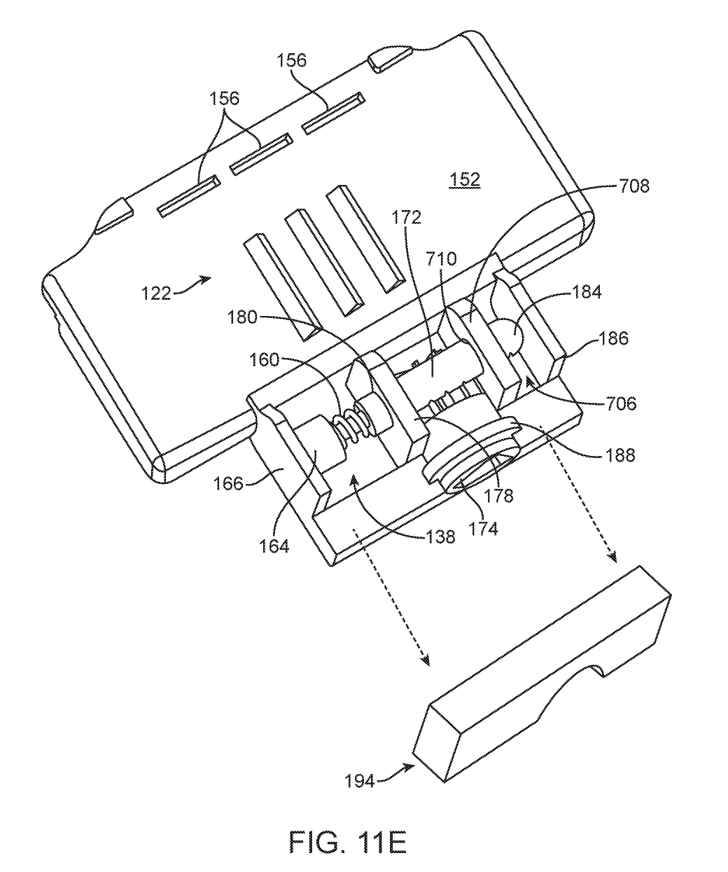

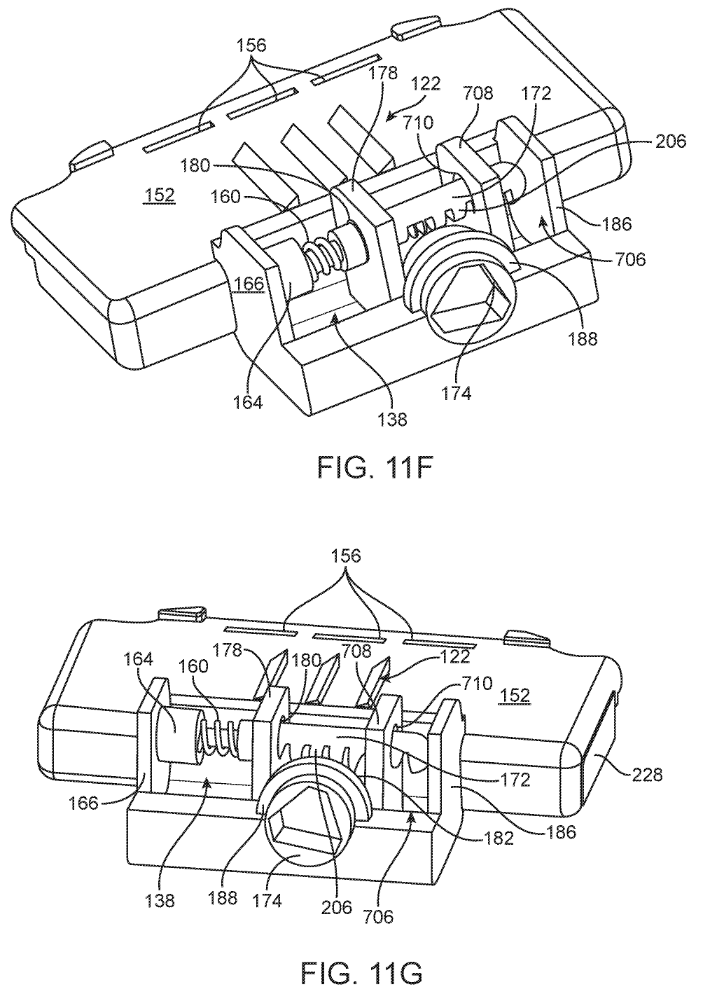

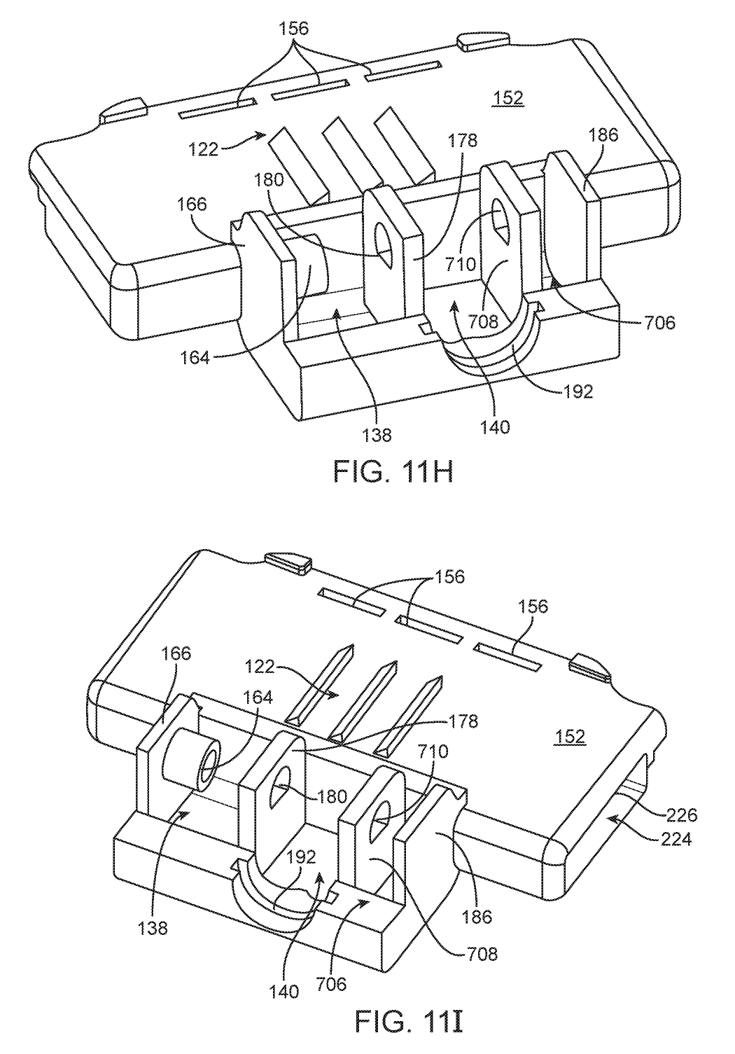

FIGS. 7A to 11I are non-limiting, exemplary illustrations of a theft deterrent tag in accordance with another embodiment of the present invention. Theft deterrent tag 100a illustrated in FIGS. 7A to 11I includes similar corresponding or equivalent components, interconnections, functional, operational, and or cooperative relationships as theft deterrent tag 100 that is shown in FIGS. 1A to 6, and described above. Therefore, for the sake of brevity, clarity, convenience, and to avoid duplication, the general description of FIGS. 7A to 11I will not repeat every corresponding or equivalent component, interconnections, functional, operational, and or cooperative relationships that has already been described above in relation to theft deterrent tag 100 that is shown in FIGS. 1A to 6.

As illustrated in FIGS. 7A to 11I, in this non-limiting, exemplary instance, theft deterrent tag 100a is comprised of first piece 110 that includes locking flanges 124 that is perpendicularly cantilevered from a cover-extension 702 from a first side 704 of first piece 110 (independent and separate from cover-flanges 134 and 136). Set of cover-flanges 134 and 136 cover lock portions (or compartments) 138 and 140 of second piece assembly 112 while locking flanges 124 is inserted into compartment 706, with cover-extension 702 covering over compartment 706.

As further illustrated, in this non-limiting, exemplary instance, one or more compartments 138, 140, and 706 of first portion 144 of second piece assembly 112 are defined by a first dividing interlock wall 178 and a second dividing interlock wall 708 that include a first guide-opening 180 and a second guide opening 710 that facilitates reciprocal (translational, linear) movement 176 of engagement member (pin) 172 of lock mechanism 146 between lock and unlock positions. The added second dividing interlock wall 708 with its second guide opening 710 facilitates in reducing potential wobbling of pin 172 as it travels along reciprocal (translational, linear) movement 176.

The preferred embodiment illustrated in FIGS. 7A to 11I includes the addition of second dividing interlock wall 708, which allows for further support of locking pin 172. The second dividing interlock wall 708 is positioned closer to third wall 186 so to not allow any prying device to enter the space in between and move the locking pin to an unlocked position. The additional wall 708 also ensures proper alignment between locking pin 172 and hole 126 of locking flange 124. Wall 708 ensures that beveled portion 128 of locking flange 124 correctly impacts locking pin 172 allowing for locking pin 172 to be forcibly pushed back, allowing the tag to lock without the need of a tool.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, inside, outside, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A theft deterrent tag, comprising:
an adjustable housing that includes:
a first piece that is mechanically moved from open, unlocked position to a closed, locked position with a second piece assembly without use of tools; and
a benefit denial mechanism.

2. The theft deterrent tag as set forth in claim 1, wherein:
the first piece is mechanically unlocked from the second piece assembly using a key.

3. The theft deterrent tag as set forth in claim 1, wherein:
the first piece is engaged with the second piece assembly at both locked and unlocked positions.

4. The theft deterrent tag as set forth in claim 1, wherein:
the first piece is comprised of:
a locking flange with an interlocking opening, the locking flange includes a beveled distal edge;
a first set of tension openings that receive a first end of a set of resilient members; and
a set of cover-flanges that cover a lock-portion of the second piece.

5. The theft deterrent tag as set forth in claim 1, wherein:
the second piece assembly is comprised of:
a first portion that houses a locking mechanism;
a second portion that houses one or more electronic modules; and
a third portion that accommodates a set of resilient members.

6. The theft deterrent tag as set forth in claim 5, wherein:
the second piece assembly is further comprised of:
a surface that accommodates the benefit denial mechanism.

7. The theft deterrent tag as set forth in claim 5, wherein:
the third portion of the second piece assembly is a second set of corresponding tension openings that receive a second end of the set of resilient members.

8. The theft deterrent tag as set forth in claim 5, wherein:
the first portion of the second piece assembly is comprised of one or more compartments that house a locking mechanism.

9. The theft deterrent tag as set forth in claim 6, wherein:
the locking mechanism is comprised of:
a resilient member;
an engagement pin that is biased to a locked position by the resilient member; and
an unlocking member that engages with the engagement pin to move the engagement pin along a linear reciprocating path from a locked position to an unlocked position.

10. The theft deterrent tag as set forth in claim 9, wherein:
a first end of the resilient member of the lock mechanism is housed within protruded cavity that extends from a first wall of the compartment.

11. The theft deterrent tag as set forth in claim 10, wherein:
a second end of the resilient member of the lock mechanism is engaged with the engagement pin.

12. The theft deterrent tag as set forth in claim 8, wherein:
the one or more compartments of the first portion of the second piece assembly is defined by one or more dividing interlock wall that includes a guide-opening that facilitates reciprocal movement of an engaging member of the lock mechanism between lock and unlock positions.

13. The theft deterrent tag as set forth in claim 9, wherein:
the engagement pin is a linear pinion.

14. The theft deterrent tag as set forth in claim 13, wherein:
the engagement pin engages with a set of gears of the unlocking member.

15. The theft deterrent tag as set forth in claim 14, wherein:
the unlocking member is a free-wheeling gear mechanism.

16. The theft deterrent tag as set forth in claim 15, wherein:
the linear, translational motion of the pinion is translated to rotation of the gears of the unlocking member and the rotation of the gears of the unlocking member is translated to linear, translational motion of the pinion.

17. The theft deterrent tag as set forth in claim 1, further comprising:
first and second protective members associated with respective first and second pieces.

18. The theft deterrent tag as set forth in claim 1, further comprising:
electronic article surveillance (EAS) module.

19. The theft deterrent tag as set forth in claim 1, further comprising:
a Radio Frequency Identification (RFID) module.

20. The theft deterrent tag as set forth in claim 1, further comprising:
electronic article surveillance (EAS) module and a Radio Frequency Identification (RFID) module.

21. The theft deterrent tag as set forth in claim 5, wherein:
the second portion is comprise of a chamber with an opening for accessing chamber that houses the one or more electronics module, with the opening closed with a cap.

22. The theft deterrent tag as set forth in claim 1, wherein:
the benefit-denial mechanism is positioned between first and second piece.

23. The theft deterrent tag as set forth in claim 1, wherein:
the benefit-denial mechanism is positioned at least on second piece.

24. The theft deterrent tag as set forth in claim 1, wherein:
the benefit-denial mechanism includes:
a set of protuberances collectively forming a serrated platform that damages the article if forcefully removed from the theft-deterrent tag.

25. The theft deterrent tag as set forth in claim 17, wherein:
one of the first and second protective members includes a piercing portion.

26. A theft deterrent tag, comprising:
an adjustable housing that includes:
a first piece that is mechanically moved from open, unlocked position to a closed, locked position with a second piece assembly without use of tools;
a benefit denial mechanism; and
an electronic article surveillance module.
